(19) United States
(12) Patent Application Publication
(10) Pub. No.: US 2012/0180486 A1
(43) Pub. Date: Jul. 19, 2012

(54) GAS TURBINE FUEL SYSTEM FOR LOW DYNAMICS

(75) Inventors: Kwanwoo Kim, Mason, OH (US); Nishant Govindbhai Parsania, Bangalore (IN); Dheeraj Sharma, Bangalore (IN)

(73) Assignee: GENERAL ELECTRIC COMPANY, Schenectady, NY (US)

(21) Appl. No.: 13/008,115

(22) Filed: Jan. 18, 2011

(51) Int. Cl. F02C 7/24; F02C 7/22

(52) U.S. Cl. 60/725; 60/734; 60/742; 60/737

(57) ABSTRACT

A combustor is provided and includes a center body having a tubular inner wall, a cartridge disposed within the tubular inner wall to define an outer annular space between an outer surface thereof and the tubular inner wall and an inner annular space having an open end and a closed end opposite the open end and an insert disposed within the outer annular space to envelop the cartridge proximate to the open end, the insert including a body having a tubular forward portion and a partially tubular aft portion, the partially tubular aft portion thereby forming a recessed track having a longitudinal axis substantially aligned with a longitudinal axis of the outer annular space.

### BACKGROUND OF THE INVENTION

The subject matter disclosed herein relates to a combustor cartridge to mitigate combustion dynamics.

In conventional gas turbine engines, mixtures of fuel and gas are combusted and the high energy fluids produced from that combustion are employed in the generation of power and electricity. The by-products of that combustion are exhausted into the atmosphere or otherwise disposed of. In either case, it is becoming increasingly necessary to limit the amount of certain pollutants in those by-products. In particular, it is often necessary to significantly reduce emissions of oxides of nitrogen (NO_{X}) and carbon monoxide (CO) in order to comply with local and national pollution regulations.

Currently, gas turbine engines may employ dry low NO_{X} (DLN) combustors, Dry Low Emissions (DLE) combustors or Lean Pre Mixed (LPM) combustion systems to achieve NO_{X} reductions. These options involve the use of lean fuel air mixtures (having, for example, equivalence ratios of 0.58 to 0.65) during fully premixed operational modes to reduce NO_{X} and CO emissions.

Because these combustors operate at such lean fuel/air (f/a) ratios, however, relatively small changes in velocity fluctuations can result in relatively large changes in mass flow and fuel air fluctuations. These fluctuations can result in large variations in the rate of heat release and can also result in high-pressure fluctuations in the combustion chambers. Meanwhile, interactions between chamber acoustics, the fuel/air fluctuations, vortex-flame interactions and unsteady rates of heat release can lead to a feed back loop mechanism resulting in dynamic pressure pulsations in the combustion system. This phenomenon of pressure fluctuations is referred to as thermo-acoustic or combustion dynamic instabilities or, more generally, combustion dynamics, which is a major problem in at least DLN combustors.

### BRIEF DESCRIPTION OF THE INVENTION

According to one aspect of the invention, a combustor is provided and includes a center body having a tubular inner wall, a cartridge disposed within the tubular inner wall to define an outer annular space between an outer surface thereof and the tubular inner wall and an inner annular space having an open end and a closed end opposite the open end and an insert disposed within the outer annular space to envelop the cartridge proximate to the open end, the insert including a body having a tubular forward portion and a partially tubular aft portion, the partially tubular aft portion thereby forming a recessed track having a longitudinal axis substantially aligned with a longitudinal axis of the outer annular space.

According to another aspect of the invention, a Dry Low NO_{X} (DLN) combustor having a multi-nozzle configuration in which each nozzle is arrayed about a common central axis is provided and includes a center body having a tubular inner wall, a cartridge disposed within the tubular inner wall to define an outer annular space between an outer surface thereof and the tubular inner wall and an inner annular space having an open end and a closed end opposite the open end and an insert disposed within the outer annular space to envelop the cartridge proximate to the open end, the insert including a body having a tubular forward portion and a partially tubular aft portion, the partially tubular aft portion thereby forming a recessed track having a longitudinal axis substantially aligned with a longitudinal axis of the outer annular space and the common central axis.

According to yet another aspect of the invention, a gas turbine engine is provided and includes a combustor and a plurality of nozzles disposed at a head end upstream from the combustor and arrayed about a common central axis, each nozzle including a center body having a cartridge disposed therein to define an outer annular space between the center body and the cartridge and an inner annular space therein having an open end and a closed end opposite the open end, and an insert disposed within the outer annular space to envelop the cartridge proximate to the open end, the insert including a body having a tubular forward portion and a partially tubular aft portion, the partially tubular aft portion thereby forming a recessed track having a longitudinal axis substantially aligned with a longitudinal axis of the outer annular space and the common central axis.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of a combustor;

FIG. 2 is a perspective view of an insert for the combustor of FIG. 1; and

FIG. 3 is a perspective view of an end of a cartridge of the combustor of FIG. 1.

The detailed description explains embodiments of the invention, together with advantages and features, by way of example with reference to the drawings.

### DETAILED DESCRIPTION OF THE INVENTION

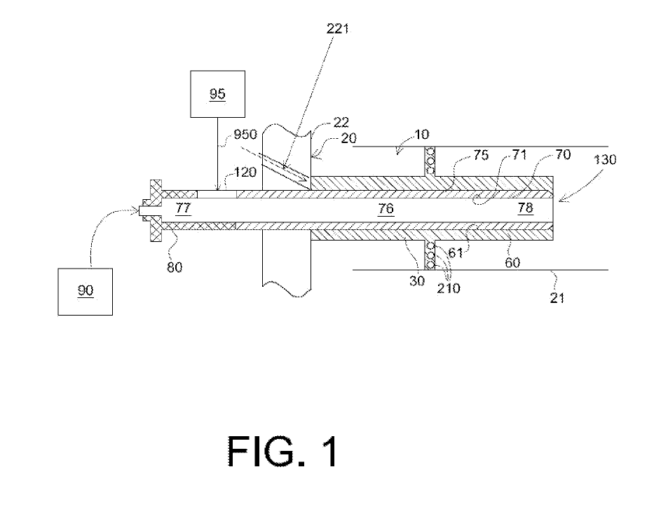

With reference to FIG. 1, a gas turbine engine 10 is provided and includes a combustor 20, such as a Dry Low NO_{X} (DLN) combustor in which mixtures of fuel and gas are combusted for the purpose of power and electricity generation, and a plurality of dual fuel capable fuel nozzles 30. The combustor 20 includes a shroud 21 and a wall 22 through which a premix passage 221 is defined. The plurality of the nozzles 30 is disposed at a head end of the gas turbine engine 10 at an axial location that is upstream from a combustion zone of the combustor 20. At this axial location, the plurality of the nozzles 30 is arrayed about a common central axis.

Each nozzle 30 includes a premixer formed by a length of the shroud 21 to mix gaseous fuel and combustion air through a swirler vane and a fuel spoke and a center body 60 disposed within the shroud 21. The center body 60 has a tubular shaped inner wall 61, a oil cartridge 70, which is housed within the center body 60 for permitting liquid fuel flow in a liquid fuel operating mode or for permitting purge air flow and no liquid for a gas only fuel mode, and an insert 80. The cartridge 70 is disposed within the tubular inner wall 61 to define an outer annular space 75 between an outer surface 71 of the cartridge 70 and the tubular inner wall 61. The cartridge 70 is generally tubular shaped and may be hollow for gas only nozzle construction and may house a liquid fuel injector for dual fuel nozzle construction.

Operation of DLN combustors, such as the combustor 20, includes various combustion modes where one mode burns non-premixed fuel with combustion air (the “combustion mode 1”) by directly injecting fuel in the combustion zone without mixing the fuel with air. In another mode, the combustor 20 burns fuel that is premixed with combustion air prior to entering the combustor 20 by injection of gaseous fuel through the fuel spoke in a premixing passage provided in the burner tube of the fuel nozzle 30 (the “combustion mode 2”). In yet another mode, the combustor 20 burns some of the fuel through diffusion mode and the rest of the fuel in the premix mode (the “combustion mode 3”).

That is, for combustion mode 1 or mode 3, the cartridge 70 further defines an inner annular space 76 having an open end 77 and a restricted end 78 opposite the open end 77 and is hollow to contain purge air for gas-only fuel nozzle design. In some cases, however, the inner annular space 76 may not be hollow and may house a liquid fuel injector. The insert 80 is disposed within the outer annular space 75 at an axial location that is proximate to the open end 77 and acts as partial blockage for diffusion fuel flow and changes acoustic response of the outer annular space 75 to dynamic pressure fluctuation that is transmitted from a hot side of the combustor 20.

A purge air circuit 90 is fluidly communicative with the open end 77 of the cartridge 70 to deliver purge air thereto during first predefined operational conditions, such as gas only conditions. Thus, the inner annular space 76 is receptive of a purge air supply via the open end 77. By contrast, the outer annular space 75 is receptive of a fuel supply, such as diffusion fuel and/or a purge air supply via a fuel/air circuit 95, which is fluidly communicative with the outer annular space 75. As shown in FIG. 1, the fuel/air circuit 95 delivers diffusion fuel and/or purge air to the outer annular space in at least a radially inwardly oriented direction 950. This is valid for gas only operations and for combustion modes 1, 2 and 3.

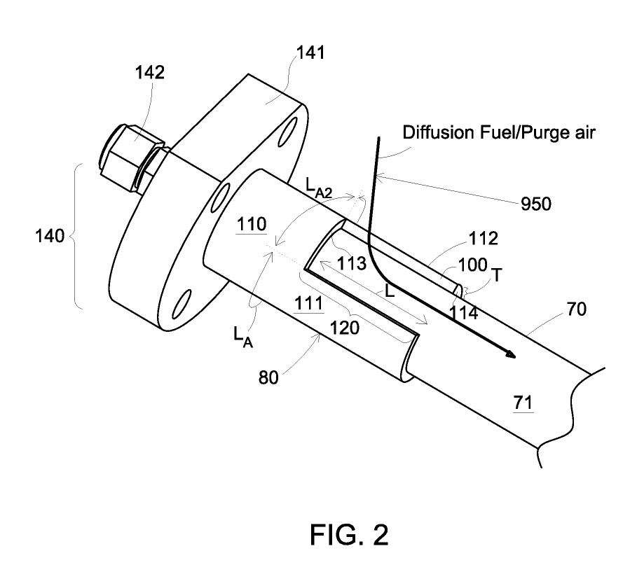

With reference to FIG. 2, the insert 80 includes a body 100 that is sized to relatively tightly envelope the cartridge 70, which is slightly narrower than the body 100. The body 100 is generally tubular at its forward portion 110 and only partially tubular at its aft portion 111. This partial tubularity defines a track 120 at the aft portion 111. That is, at the aft portion 111, the body 100 is generally tubular along a circumferential arc-length, L_{A}, but does not extend through circumferential arc-length, L_{A2}. The circumferential arc-length, L_{A2}, is provided such that the track 120 forms a significant flow restriction and can be tuned for adjusting acoustic response to combustion dynamics. Longitudinal length, L, of the track 120 is substantially aligned and, in some cases, parallel with a longitudinal axis of the outer annular space 75. This is one example embodiment of achieving partial blockage for flow.

As shown in FIG. 2, the body 100 includes a tubular face 112, a longitudinally recessed face 113 and an end face 114 each of which has a thickness, T, corresponding to a thickness of the body 100. The end face 114 and the longitudinally recessed face 113 each face in the aft direction and a plane of the longitudinally recessed face 113 is longitudinally recessed from a plane of the end face 114 to thereby define a longitudinal extent of the recessed track 120. The tubular face 112 extends radially from an outer surface of the insert 80 to the outer surface 71 of the cartridge 70.

With the insert 80 provided in the outer annular space 75 around the cartridge 70, the diffusion fuel and/or the purge air supplied to the outer annular space 75 is delivered to the outer annular space 75 at the track 120 with the radially inward orientation and then directed axially aft in accordance with a shape of the track 120. As such, injected acoustic pressure fluctuations can be dampened or resonated in accordance with a given resonant frequency of the combustor to thereby absorb pressure fluctuations of a targeted frequency and/or to decouple heat release fluctuations from acoustic pressures leading to combustion dynamics mitigation.

In particular, since the insert 80 may be positioned proximate to an end of the fuel/air circuit 95 such that the radially inward delivery of the fuel and/or the purge air by way of the fuel/air circuit 95 is directed towards the track 120, the delivery of the incoming diffusion fuel, which will react at a diffusion flame front and is susceptible to diffusion flame fluctuation, may be stiffened/softened or detuned from acoustic responses to reduce diffusion flame fluctuation and provide combustion dynamics mitigation for the gas turbine engine 10.

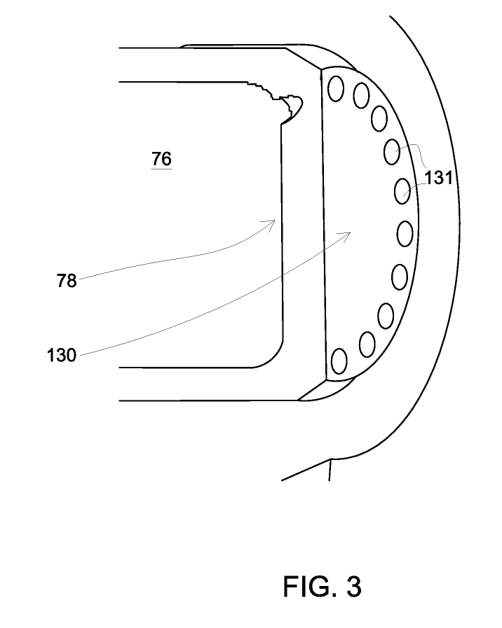

In accordance with further embodiments and with reference to FIG. 3, the combustion dynamic mitigation may be achieved by further changes to cartridge 70 internal volume, numbers of upstream and downstream feed holes and diameters and neck lengths of those feed holes. Cartridge 70 internal volume, restrictive upstream holes at a flange side proximate to the open end 77 and acoustically open downstream feed holes at a heat shield side proximate to the closed end 78 allow the cartridge 70 to act as quarter wave tube for attenuation of acoustic fluctuation from combustor pressure fluctuation. In particular, a heat shield 130 of the cartridge 70, which is disposed at the closed end 78 of the inner annular space 76, may be formed to define multiple through-holes 131 through which combustor 20 and a nozzle tip fluidly communicate. Up to 20 or more through-holes 131 may be provided in an ovoid array about a centerline of the cartridge 70. Each through-hole 131 may be substantially straight and aligned with the longitudinal axis of the cartridge 70.

The various embodiments described above can be used alone or in combination with one another. For example, during diffusion fuel turbine operations of combustion mode 1, combustion fuel passing through insert 80 will be diffusion fuel employed in each nozzle 30 for combustion dynamics mitigation. For combustion mode 3 operation, the insert 80 will be employed in each nozzle 30 with at least one of the nozzles 30 provided with the additional through-holes 131. For piloted premix (PPM) operations, the insert 80 and the additional through-holes 131 will be provided for each nozzle 30 and, for premix operations of combustion mode 2, only the additional through-holes 131 will be employed for each of the nozzles 30 for combustion dynamics mitigation.

With reference back to FIG. 2, the insert 80 further includes a head portion 140. The head portion 140 includes a flange 141 by which the insert 80 is connectable with the center body 60 and a nozzle 142. The nozzle 142 is connectable with the purge air circuit 90 such that the purge air is deliverable to the inner annular space 76.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor, comprising:
a center body having a tubular inner wall;
a cartridge disposed within the tubular inner wall to define an outer annular space between an outer surface thereof and the tubular inner wall and an inner annular space having an open end and a closed end opposite the open end; and
an insert disposed within the outer annular space to envelop the cartridge proximate to the open end, the insert including a body having a tubular forward portion and a partially tubular aft portion,
the partially tubular aft portion thereby forming a recessed track having a longitudinal axis substantially aligned with a longitudinal axis of the outer annular space.

2. The combustor according to claim 1, wherein a longitudinal length of the track is parallel with the longitudinal axis of the outer annular space.

3. The combustor according to claim 1, wherein the inner annular space is receptive of a purge air supply via the open end.

4. The combustor according to claim 1, wherein the track and the outer annular space are receptive of a diffusion fuel supply or a purge air supply.

5. The combustor according to claim 4, wherein the fuel supply or the purge air supply are injected radially inwardly at the track.

6. The combustor according to claim 1, wherein the cartridge is further formed to define a plurality of through-holes at the closed end,
at least a cartridge volume, restrictive upstream holes at a flange side and the through-holes allow the cartridge to attenuate acoustic fluctuation from combustor pressure fluctuation.

7. The combustor according to claim 1, wherein the aft portion of the body comprises a tubular face, a recessed face and an end face,
the recessed face being longitudinally recessed from the end face at the track, and
the tubular face extending radially from an outer surface of the insert to the outer surface of the cartridge, and
wherein the recessed face partially blocks diffusion fuel flow and changes acoustic response of the outer annular space to dynamic pressure fluctuations.

8. The combustor according to claim 1, wherein the insert further includes a head portion, the head portion comprising:
a flange connectable with the center body; and
a nozzle connectable with a purge air circuit.

9. A Dry Low NO_{X} (DLN) combustor having a multi-nozzle configuration in which each nozzle is arrayed about a common central axis and comprises:
a center body having a tubular inner wall;
a cartridge disposed within the tubular inner wall to define an outer annular space between an outer surface thereof and the tubular inner wall and an inner annular space having an open end and a closed end opposite the open end; and
an insert disposed within the outer annular space to envelop the cartridge proximate to the open end, the insert including a body having a tubular forward portion and a partially tubular aft portion,
the partially tubular aft portion thereby forming a recessed track having a longitudinal axis substantially aligned with a longitudinal axis of the outer annular space and the common central axis.

10. The combustor according to claim 9, wherein a longitudinal length of the track is parallel with a longitudinal axis of the outer annular space and the common central axis.

11. The combustor according to claim 9, wherein the inner annular space is receptive of a purge air supply via the open end.

12. The combustor according to claim 9, wherein the track and the outer annular space are receptive of a diffusion fuel supply or a purge air supply.

13. The combustor according to claim 12, wherein the diffusion fuel supply or the purge air supply are injected radially inwardly at the track.

14. The combustor according to claim 9, wherein the cartridge is further formed to define a plurality of through-holes at the closed end.

15. The combustor according to claim 9, wherein the aft portion of the body comprises a tubular face, a recessed face and an end face,
the recessed face being longitudinally recessed from the end face at the track, and
the tubular face extending radially from an outer surface of the insert to the outer surface of the cartridge.

16. The combustor according to claim 9, wherein the insert further includes a head portion, the head portion comprising:
a flange connectable with the center body; and
a nozzle connectable with a purge air circuit.

17. A gas turbine engine, comprising:
a combustor; and
a plurality of nozzles disposed at a head end upstream from the combustor and arrayed about a common central axis, each nozzle including:
a center body having a cartridge disposed therein to define an outer annular space between the center body and the cartridge and an inner annular space therein having an open end and a closed end opposite the open end, and
an insert disposed within the outer annular space to envelop the cartridge proximate to the open end, the insert including a body having a tubular forward portion and a partially tubular aft portion,
the partially tubular aft portion thereby forming a recessed track having a longitudinal axis substantially aligned with a longitudinal axis of the outer annular space and the common central axis.

18. The gas turbine engine according to claim 17, wherein the combustor comprises a Dry Low NO_{X} (DLN) combustor.

19. The gas turbine engine according to claim 17, further comprising a purge air circuit fluidly communicative with the open end of the cartridge to deliver purge air thereto during first predefined operational conditions.

20. The gas turbine engine according to claim 17, further comprising a diffusion fuel/purge air circuit fluidly communicative with the outer annular space to deliver fuel and/or purge air thereto during second predefined operational conditions.

21. The gas turbine engine according to claim 17, being operable in multiple combustion modes including a first mode, a second mode and a third mode.

22. The gas turbine engine according to claim 17, having dual fuel capability, wherein a premix passage and the outer annular space are common and the inner annular space replaceable with a liquid fuel cartridge.
